(19) United States
(12) Patent Application Publication
(10) Pub. No.: US 2001/0056321 A1
(43) Pub. Date: Dec. 27, 2001

(54) ON-BOARD APPARATUS FOR EVALUATING POSITIONING SIGNALS RECEIVED FROM AT LEAST ONE SENDER

(76) Inventors: HEINZ DECKER, VAIHINGEN (DE); JUERGEN BRAUENINGER, STUTTGART (DE)

Correspondence Address: STRIKER STRIKER & STENBY, 360 LEXINGTON AVENUE, NEW YORK, NY, 10017, US

(21) Appl. No.: 08/817,038

(22) PCT Filed: Jul. 6, 1996
(86) PCT No.: PCT/DE96/01209

§ 371 Date: None

(30) Foreign Application Priority Data
Aug. 1, 1995 (DE) 195 28 183.7

(51) Int. Cl. G06F 7/70

(52) U.S. Cl. 701/70

(57) ABSTRACT

According to the invention, an in-vehicle device for evaluating received position signals from at least one transmitter located outside a vehicle is proposed, which from subsequently ascertained position data determines various motion parameters of the vehicle. These motion parameters, such as the vehicle speed, acceleration, and change in rotational and directional angles are used to control devices for the vehicle or the engine. For instance, from the ascertained speed signal, an ABS brake system [!] or a vehicle speed limiter [cruise control?] can be controlled. Alternatively, the motion parameters can be output on a display.

### PRIOR ART

The invention is based on an in-vehicle device for evaluating position signals received from at least one transmitter located outside a vehicle, as generically defined by the preamble to the main claim. Using the global positioning system (GPS), it is already known to ascertain an instantaneous position on the earth to a precision of a few meters, with the aid of at least three transmitted satellite signals. This kind of position determination is used for instance to determine the position of motor vehicles, ships or aircraft. It is also known, to determine motion parameters of a vehicle, to use sensors that for instance measure travel pulses at the wheels in order to measure the speed or acceleration of the vehicle. These measured values are used for instance for the speedometer display or to control or regulate the engine or the vehicle.

The in-vehicle device according to the invention as defined by the characteristics of the body of the main claim has the advantage over the prior art that sensors in the vehicle can be dispensed with, since the required vehicle motion parameters, which could previously be furnished only by the sensors, can be ascertained from the data of the positional determination. It is especially advantageous that the motion parameters ascertained from the vehicle position are independent of the tire pressure or tire wear, for instance, since the number of wheel rotations is no longer of significance to determine the distance traveled or the speed.

By means of the provisions recited in the dependent claims, advantageous further features of and improvements to the in-vehicle device recited in the main claim are possible. It is especially advantageous that by the two-dimensional positional determination in the plane in which the vehicle is driving, the vehicle speed can be ascertained in a simple way, so that this speed value can be output, for instance, on the speedometer display as well. Moreover, from the speed signal, the vehicle acceleration or deceleration can advantageously be ascertained. These motion parameters can be used as reference values in vehicle speed regulation or in brake control.

In three-dimensional positional determination, the advantage is obtained that with sufficient precision of the parameter determination, the respective vehicle height above the road can also be measured. From these height indications, values on regulating or adjusting the inclination, on monitoring the tire pressure, or on the vehicle load status can be obtained. If a plurality of receivers for the transmitter signals are mounted at various suitable points of the vehicle, then the roll, pitch, or yaw angle of the vehicle can for instance be determined from the ascertained values. With the aid of these angles, it advantageously becomes possible to regulate driving dynamics.

Suitable transmitters for positional determination include the global positioning system (GPS), GPS Navstar, or PRARE (Precise Range and Range Rate Experiment), for instance, in which many satellites already orbit the earth and which are already used for military and civilian purposes. Alternatively, ground-based transmitters may also be provided, which in the relevant driving range of the vehicle transmit their signals to the vehicle so that the in-vehicle device can from them determine its instantaneous position.

### DRAWING

One exemplary embodiment of the invention is shown in the drawing and described in further detail in the ensuing description.

FIG. 1 shows a vehicle with an in-vehicle device;

FIG. 2 is a block circuit diagram; and

FIG. 3 shows a current flow chart.

### DESCRIPTION OF THE EXEMPLARY EMBODIMENT

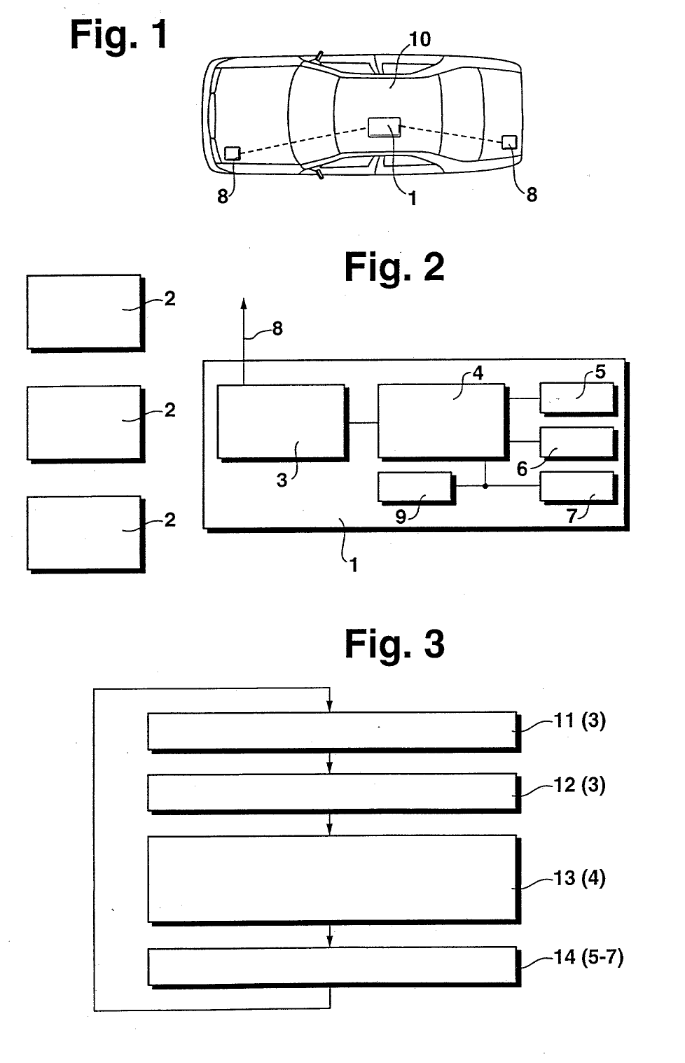

FIG. 1 shows a vehicle in the form of a motor vehicle 10, in the front and rear regions of which antennas 8 are mounted. The antennas 8 are electrically connected to an in-vehicle device 1. In the simplest case, a two-dimensional (horizontal) positional determination in the driving plane is adequate. The antenna 8 receives signals of the transmitters 2 and can determine the instantaneous vehicle position from phase difference or transit time difference measurements of the transmitted signals of the transmitters 2. In principle, it suffices to receive from at least two transmitters. In three-dimensional positional determination, the height in the vertical axis of the vehicle relative to the road surface or to the vehicle can be measured in addition. For instance, if one receiving antenna 8 each is mounted at the front and rear of the vehicle, then from the positional determinations of the two antennas 8, their relative change can be ascertained. From the relative change and the derivations over time, angular motions and transverse accelerations of the vehicle can thus be determined.

With the aid of such motion parameters, dynamic driving controls can be constructed.

FIG. 2 is a block circuit diagram of the in-vehicle device 1, which is connected by radio to a plurality of transmitters 2. These transmitters 2 are either satellite transmitters, such as GPS satellites, or ground-based transmitters, which are preferably installed within driving range of the vehicle or in the form of radio transmitters. The GPS satellite system is known per se and therefore need not be described in detail here. Suitable position computers 3 are also known, in which from the received satellite signals can determine the instantaneous position of the vehicle 10. For a positional determination with the GPS system, the reception of at least three satellite signals is necessary. The more satellites can simultaneously be received, the better the positional accuracy that can be calculated from the received signals. In the in-vehicle device 1, this kind of known position computer 3 is known, which receives the satellite signals via one or more antennas mounted at suitable points of the vehicle and evaluates them. Thus at every moment, the position computer 3 ascertains a position for the vehicle, or more precisely the position of the receiving antenna. If these positional data are reported during the travel of the vehicle to a motion computer 4 at predetermined time intervals, then from the difference among these signals the motion computer 4 can calculate various motion parameters of the vehicle 10. From two positional indications, the distance traveled by the vehicle 10 can thus be calculated by subtraction. If this distance is referred to the elapsed time, then an average speed for the vehicle 10 is obtained. By differentiation in accordance with time, the acceleration or deceleration of the vehicle can also be determined. These individual motion parameters of the vehicle 10 are further processed in a suitable device 5-7. As the device 5, a speedometer or trip plotter on which the instantaneous speed is displayed is for instance contemplated. At position 6, an automatic brake system (ABS) is provided, in which the value of the vehicle speed can be used for regulating the brake force. The device 7 has a vehicle speed limiter FGB, which compares the speed ascertained at any given time with a predetermined set-point value.

A further feature of the invention contemplates the control of still other devices, such as parking assistance or a spacing measuring device, with the aid of the ascertained motion parameters.

The motion computer 4 substantially includes a computer and a memory, which from the arriving data of the position computer 3 calculates the vehicle speed and acceleration, for instance, and outputs it selectively on a gauge 9. For two-dimensional (horizontal) positional determination, it suffices to receive at least three signals. In three-dimensional positional determination, the height of the vehicle above the ground, or changes therein, can additional be ascertained. If a plurality of measurement points are provided in the vehicle, in particular, then from the difference among these various measured values, any change in the vehicle direction in all three axes can be determined. With the aid of these motion parameters, dynamic vehicle control can advantageously be performed.

The mode of operation of this arrangement will be described in further detail now in conjunction with FIG. 3. First, the position computer 3 waits for a time slot in which it can receive transmitted signals (position 11). From these signals, the instantaneous position of the vehicle 10 is calculated and reported to the motion computer 4. At position 13, the motion computer 4 compares the new position report with the previous ones and from the difference ascertains the desired motion parameters. These motion parameters are output in an output 14 or are output to the connecting devices 5-7 and 9. After that, the cycle begins over again at position 11.

Instead of satellite transmitters, ground-based transmitters may also be used, which transmit synchronously as radio transmitters, for instance. Such transmitters are often receivable in the ball reception mode in a driving range. With the aid of phase difference measurements, the position of the vehicle relative to the location of the transmitters can thus also be determined. Such computation methods are likewise known and therefore need not be described in detail here.

1. An in-vehicle device for evaluation received position signals from at least one transmitter, located outside a vehicle, that can be used to determine the position of the vehicle, characterized in that the in-vehicle device (1) has means (4) with which motion parameters of the vehicle (10) can be determined from the position data of the vehicle (10).

2. The in-vehicle device of claim 1, characterized in that the means (4) ascertain the positional determination two-dimensionally in the driving plane at one point in the vehicle (10).

3. The in-vehicle device of claim 2, characterized in that as the motion parameters, preferably the vehicle speed, the acceleration and/or the driving direction can be ascertained.

4. The in-vehicle device of one of the foregoing claims, characterized in that the means (4) determine the position at at least one point of the vehicle (10) three-dimensionally. [German literally says determine the positional determination at at least one point . . . ]

5. The in-vehicle device of claim 4, characterized in that the motion parameters that can be ascertained are preferably the height of the vehicle (10), the vehicle inclination, and/or a rotational angle about one of the three axes.

6. The in-vehicle device of claim 3, characterized in that a device (5-9 and 9) is provided, which uses the ascertained motion parameters for controlling the vehicle (10). [control/regulate=Steuern/Regeln throughout. Also, device 5-7 and 9 but once was only 5-7]

7. The in-vehicle device of claim 6, characterized in that the device is a brake system (6), a spacing or vehicle speed regulator, a driving dynamic regulator (7), and/or a speedometer (5). [regulator=controller]

8. The in-vehicle device of one of the foregoing claims, characterized in that a display (9) can be provided for outputting a motion parameter.

9. The vehicle speed controller [sic—different term] of one of the foregoing claims, characterized in that the transmitter (2) is part of a satellite system, preferably the global positioning system.

10. The in-vehicle device of one of claims 1-8, characterized in that the transmitter (2) is a ground-based transmitter.
